(19) United States
(12) Patent Application Publication
(10) Pub. No.: US 2013/0243965 A1
(43) Pub. Date: Sep. 19, 2013

(54) METHOD OF PREPARING GRAPHENE FROM ORGANIC MATERIAL USING RADIATION TECHNIQUE AND GRAPHENE PREPARED USING THE SAME

(71) Applicants: KOREA ATOMIC ENERGY RESEARCH INSTITUTE, Daejeon (KR); KOREA HYDRO & NUCLEAR POWER CO., LTD., Seoul (KR)

(72) Inventors: Jae Hak CHOI, Daejeon (KR); Chan Hee Jung, Gwangju (KR); In Tae Hwang, Jeonju-si (KR); Dong Woo Kang, Gwangju (KR)

(73) Assignees: KOREA HYDRO & NUCLEAR POWER CO., LTD., Seoul (KR); KOREA ATOMIC ENERGY RESEARCH INSTITUTE, Daejeon (KR)

(21) Appl. No.: 13/689,063

(22) Filed: Nov. 29, 2012

(30) Foreign Application Priority Data
Mar. 15, 2012 (KR) 10-2012-0026559

(51) Int. Cl. C01B 31/04

(52) U.S. Cl. CPC C01B 31/0446; Y10S 977/842; B82Y 40/00
USPC 427/504; 427/496; 427/507; 427/506; 977/842

(57) ABSTRACT

Provided are a method for preparing grapheme from an organic material using a radiation technique, and graphene prepared using the same, and more particularly, a method of preparing graphene by dissolving an organic material such as polymer, oligomer, or the like, in a solvent to prepare an organic material solution, applying the prepared solution to an upper portion of a substrate to form an organic thin film, introducing a cross-link structure into the organic thin film through irradiation with radiation, and then performing a carbonization process, and graphene prepared using the same.

With a method of preparing graphene from an organic material using a radiation technique, and graphene prepared using the same according to the present invention, expensive metal catalyst and substrate, oxidation and reduction processes, and a delicate process control may not be required as compared to the existing method.

### CROSS-REFERENCE TO RELATED APPLICATIONS

This application claims priority under 35 U.S.C. §119 to Korean Patent Application No. 10-2012-0026559, filed on Mar. 15, 2012, in the Korean Intellectual Property Office, the disclosure of which is incorporated herein by reference in its entirety.

### TECHNICAL FIELD

The following disclosure relates to a method of preparing graphene from an organic material using a radiation technique, and graphene prepared using the same. More specifically, the following disclosure relates to a method of preparing graphene by dissolving an organic material such as polymer, oligomer, or the like, in a solvent to prepare organic material solution, applying the prepared solution onto a substrate to form an organic thin film, introducing a cross-link structure into the organic thin film through irradiation of radiation rays, and finally performing a carbonization process.

### BACKGROUND

Graphene, which has been recently spotlighted as an ideal new material, is obtained by separating a single layer of graphite having an atom structure formed through stacking layers in which carbons are arranged in a hexagonal net such as a honeycomb shape. When it has a perfect structure, this graphene exhibits a charge mobility 100 times higher than that of a single crystalline silicon, current density characteristics 100 times higher than that of copper in an ideal structure, and excellent thermal conductivity, chemical resistance, flexibility, and elasticity. Therefore, graphene has potential for the applications in various electric and electronic fields, bio-fields, and energy fields such as an ultra-speed transistor, a flexible memory device, a biomimetic device, a solar cell, and the like.

To realize this applicability, a technology of economically preparing graphene having high quality on a large scale and large area while consuming low energy has been required, such that many researches into the development of this technology have been conducted around the world.

An example of methods of preparing graphene developed up to now includes a mechanical exfoliation method of exfoliating graphene layers through mechanically breaking the weak interlayer interaction force of graphite crystal a chemical exfoliation method of exfoliating a graphite crystal through chemical oxidation followed by the reduction of oxidized graphene to graphene, a chemical vapor deposition method of synthesizing graphene using a transition metal catalyst layer absorbing carbon at high temperature, and an epitaxy method of synthesizing graphene through growing carbon included in a silicon carbide crystal along a grain of the surface at a high temperature.

In the case of the mechanical exfoliation method, the prepared graphene has a micro meter scale size, and the yield is significantly low, such that there are many limitations in actual applications. In the case of the chemical vapor deposition method, an expensive transition metal catalyst, and a delicate process control are required. In the case of epitaxy method, an expensive silicon carbide (SiC) substrate is required and the fabrication of devices is difficult. Lastly, in the case of the chemical exfoliation method, graphene can be prepared at a large scale, but the electric properties cannot be completely recovered by reducing the oxidized graphene.

As the related art of graphene preparation method, a method of depositing a thin layer containing an amorphous carbon on a substrate and annealing the thin layer through irradiating with photons and electrons to obtain a layer including graphene is disclosed in US Patent Laid-Open Publication No. 2010-0247801 (Sep. 30, 2010). However, in this method, it may be difficult to control the preparation process and the costs may be expensive.

In addition, in Korean Patent Laid-open Publication No. 2011-0056869 (May 31, 2011), a molecular beam epitaxy method of mounting a substrate in a molecular beam epitaxy chamber and supplying carbon source on the substrate in the chamber to form graphene on the substrate is disclosed. However, when graphene is formed, by this epitaxy method, the resulting graphene does not have excellent properties as compared to graphene prepared through a chemical vapor deposition (CVD) method, the raw materials are expensive, and it is difficult to prepare the graphene.

Therefore, in order to resolve these problems and prepare graphene capable of being applied as various organic electronic devices such, as a solar cell, an organic light emitting device, or a non-volatile organic memory device, research into a method of preparing graphene capable of being prepared by a simple preparing process at low preparing cost, being easily treated, and producing graphene with improved thermal, mechanical, and electrical properties has been conducted.

### RELATED ART DOCUMENT

### Patent Document

(Patent Document 1) US Patent Laid-open Publication No. 2010-0247801 (Sep. 30, 2010)
(Patent Document 2) Korea Patent Laid-Open Publication No. 2011-0056869 (May 31, 2011)

### SUMMARY

An embodiment of the present invention is directed to provide a method of preparing graphene by carbonizing the organic material cross-linked using radiation without an expensive metal catalyst or substrate. According to the present invention, high-quality graphene may be prepared on a large area at low cost- and the process may be easily controlled.

In addition, another embodiment of the present invention is directed at providing graphene prepared by this method.

Further, another embodiment of the present invention is directed to providing a conductive thin film, a transparent electrode, a memory device using the graphene.

In a general aspect, the method of preparing graphene by forming an organic thin film on a substrate, irradiating the formed organic thin film with radiation rays to cross-link the organic thin film, and then carbonizing the cross-linked organic thin film is provided.

In another general aspect, the graphene prepared through this method is provided.

### BRIEF DESCRIPTION OF THE DRAWINGS

FIG. 1 is a mimetic diagram showing a method of preparing graphene from an organic, material according to an exemplary embodiment of the present invention;

FIG. 2 is a graph showing Fourier transform-infrared (FT-IR) spectra. Here, (a), (b), and (c) are FT-IR spectra of polyacrylonitrile of Comparative example 1, polyacrylonitrile of Example 4, and graphene prepared by carbonization of Example 4, respectively;

FIG. 3 is a graph showing Raman spectra. Here, (a) is a Raman spectrum of Comparative example 1, and (b) is a Raman spectrum of graphene prepared by carbonization of Example 4;

FIG. 4 is a graph showing element ratios of oxygen to carbon ([O]/[C]) before and after carbonization of Comparative example 1 and Examples 1 to 4;

FIG. 5 is a graph showing element ratios of nitrogen to carbon ([N]/[C]) before and after carbonization of Comparative example 1 and Examples 1 to 4;

FIG. 6 is a graph showing electrical conductivities of Comparative example 1 and graphene prepared by carbonization, of Examples 1 to 4; and

FIG. 7 is a graph showing electrical conductivities of Comparative example 2 and graphene prepared by carbonization of Example 23.

### DETAILED DESCRIPTION OF EMBODIMENTS

Hereinafter, a method for preparing graphene from, an organic material using a radiation technique, graphene prepared using the same according to exemplary embodiments of the present invention, and a method of measuring the properties of the prepared graphene will be described in detail. Hereinafter, the present invention will be understood and appreciated more fully from the following embodiments, and the embodiments are for illustrating the present invention and not for limiting the present invention defined by the accompanying claims.

Hereinafter, a method for preparing graphene will be described, in detail.

The present invention relates to a method of preparing graphene by forming an organic thin film on a substrate, irradiating the formed organic, thin film with radiation to cross-link the organic thin film, and then carbonizing the cross-linked organic, thin film.

More specifically, the radiation used in the method of preparing graphene according to the present invention may be at least one selected from a group consisting of an ion beam, an electron beam, gamma rays, alpha rays, and beta rays.

The radiation may be the ion beam, and ion beam irradiation energy (Eᵢₒₙ) and the total ion irradiation amount (Tᵢₒₙ) may satisfy the following Equations 1 and 2, respectively.

1≦Eᵢₒₙ≦300 keV [Equation 1]

1×10¹⁰≦Tᵢₒₙ≦1×10¹⁹ ions/cm² [Equation 2]

The radiation ray is the electron beam, and electron beam irradiation energy (Eₑₗₑ) and the total electron irradiation amount (Tₑₗₑ) may satisfy the following Equations 3 and 4, respectively.

1≦Eₑₗₑ≦1000 keV [Equation 3]

1×10¹⁴≦Tₑₗₑ≦1×10²⁰ electrons/cm² [Equation 4]

In the present invention, the organic thin film may be formed by applying an organic material solution obtained by dissolving one or at least two organic materials selected from polyacrylonitrile homopolymers, acrylonitrile copolymers, lignin, pitch, rayon, polystyrene, and polymethylmethacrylate in a solvent to the substrate.

In addition, the acrylonitrile copolymer may be at least one kind selected from poly (acrylonitrile-co methyl methacrylate), poly (acrylonitrile-co methyl acrylate), and poly (acrylonitrile-co vinyl acetate).

The content of the organic material may be 0.01 to 20 weight % based on the total weight of the organic material solution, and the thickness of the organic thin film may be 0.001 to 1 μm.

In the present invention, the carbonization may be performed at 800 to 1500° C. for 0.5 to 3 hours under an inert atmosphere.

In addition, a thermal stabilizing operation may be further performed at 200 to 400° C. for 1 to 3 hours before carbonization of the cross-linked organic, thin film.

In the present invention, the organic thin film may be patterned.

The patterning may be performed by positioning a pattern mask on the organic thin film, forming an pattern of organic materials by irradiation of radiation, and carbonizing the organic pattern to form a conductive pattern.

Hereinafter, an aspect of the present invention will be described in detail.

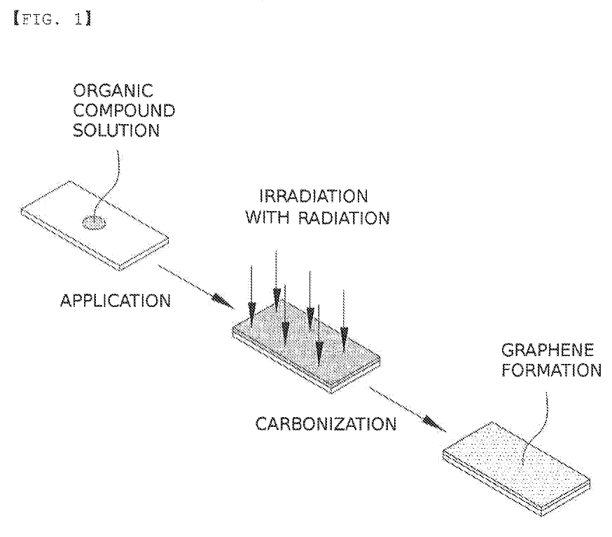

FIG. 1 shows a method of preparing graphene using a radiation technique according to an exemplary embodiment of the present invention. Referring to FIG. 1, an organic thin film is formed on a substrate, radiation is irradiated to cross-link the organic thin film, and then carbonization is performed, such that graphene may be formed.

Any substrate may be used without limitation as long as a thin film may be formed thereon, and particularly, the substrate may be a silicon wafer, a glass substrate, or a quartz substrate.

An organic material for forming the organic thin film may be at least one or two kinds selected from polyacrylonitrile homopolymers, acrylonitrile copolymers, lignin, pitch, rayon, polystyrene, and polymethylmethacrylate.

In the acrylonitrile copolymer, the 85 weight % or more content of acrylonitrile may be more may be effective and particularly, at least one kind selected from poly (acrylonitrile-co-methyl methacrylate, poly (acrylonitrile-co-methyl acrylate), and poly (acrylonitrile-co-vinyl acetate) in which contents of acrylonitrile may be 85 weight % or more may be effective. When this copolymer with the 85 weight % or more content of acrylonitrile is used, conductivity may become excellent at the time of carbonizing the organic thin film.

Further, a solvent for dissolving the organic material is not limited as long as the solvent is an organic solvent for dissolving general polymers, and particularly, may contain at least one or two kinds selected from a group consisting of dimethylformamide (DMF), formaldehyde, chloroform, dimethylacetamide (DMA), pyridine, benzopyridine (quinoline), benzene, xylene, toluene, dioxane, tetrahydrofuran (THF), diethylether, dimethyl sulfoxide (DMSO), and n-methyl-2-pyrrolidone (NMP).

In the organic material solution prepared by dissolving the organic material in the solvent, the content of the organic material may be preferably 0.01 to 20 weight % based on the total weight of the organic material solution, and more preferably 0.3 to 5 weight %. When the content of the organic material is lower than 0.01 weight %, it is difficult to form an organic thin film, and, when the content is higher than 20 weight %, the organic thin film is formed at a significantly thick thickness, such that radiation rays do not pass through to insufficiently cross-link the organic material. Therefore, the properties of graphene may be deteriorated at the time of carbonization.

The organic thin film may be formed by applying the organic material solution to the substrate. As a method of applying the organic material solution to the substrate, a generally known method such as a roll coating method, a spray coating method, an impregnation coating method, a spin coating method, or the like, may be used without limitation, and particularly, application using the spin coating method may be effective.

The thickness of the organic thin film applied to the substrate may be 0.001 to 1 μm, and more preferably, 0.005 to 0.04 μm. The organic material, solution is formed at an optimal thickness on the substrate, such that graphene having a stable structure may be formed, thereby obtaining graphene having improved mechanical and electrical properties.

When the thickness of the organic thin film is thinner than 0.001 μm (1 nm), the organic material becomes completely combusted in the process of carbonization, such that graphene may not be formed, and, When the thickness thereof is thicker than 1 μm, the organic thin film becomes significantly thick, such that graphite consisting of several layers of graphene may be formed rather than one layer of graphene.

In addition, the organic thin film formed on the substrate may be irradiated with the radiation, such that the organic thin film may be cross-linked. That is, as shown in FIG. 1, the prepared organic thin film is irradiated with a radiation such as an ion beam, electron beam, gamma ray, alpha ray, beta ray, or the like, such that the organic thin film may be cross-linked. The irradiation of the radiation ray may be performed at room temperature in order to prevent thermal deformation or pyrolysis of the organic thin film.

Further, when the ion beam is irradiated as the radiation, ions from the gases such as carbon, oxygen, hydrogen, argon, helium, neon, xenon, or the like, may be used alone or in combination, and current density may be 0.1 to 30 μA/cm², and more preferably, 0.1 to 10 μA/cm². When the current density is lower than 0.1 μA/cm², cross-link efficiency of the organic thin film becomes significantly low, such that it may be difficult to form graphene in the process of carbonization, and, when the current density is higher than 10 μA/cm², the organic thin film is thermally changed, and thus more amorphous carbon may be formed, such that it may be difficult to prepare graphene having excellent mechanical and electrical properties.

When the ion beam is irradiated as the radiation, the ion beam irradiation energy (Eᵢₒₙ) and the total ion irradiation amount (Tᵢₒₙ) may satisfy the following Equations 1 and 2.

1≦Eᵢₒₙ≦300 keV [Equation 1]

1×10¹⁰≦Tᵢₒₙ≦1×10¹⁹ ions/cm² [Equation 2]

When the total ion irradiation amount (Tᵢₒₙ) is smaller than 1×10¹⁰ ions/cm², the organic material may not be sufficiently cross-linked, and in the case in which the total ion irradiation amount (Tᵢₒₙ) is larger than 1×10¹⁹ ions/cm², thermal deformation or pyrolysis of the organic material may be generated.

When the electron beam is irradiated as the radiation, the electron beam irradiation energy (Eₑₗₑ) and the total electron irradiation amount (Tₑₗₑ) may satisfy the following Equations 3 and 4, respectively.

1≦Eₑₗₑ≦1000 keV [Equation 3]

1×10¹⁴≦Tₑₗₑ≦1×10²⁰ electrons/cm² [Equation 4]

When the total electron irradiation amount (Tₑₗₑ) is smaller than 1×10¹⁴ electrons/cm², the organic material may not be sufficiently cross-linked, and when the total electron irradiation amount (Tₑₗₑ) is larger than 1×10²⁰ electrons/cm², thermal deformation or pyrolysis of the organic material, may be generated.

Further, the organic thin film cross-linked by irradiation with the radiation may be carbonized, such that graphene may be prepared. An aromatic carbon-carbon double bond in a hexagonal ring shown in carbon-based materials is formed through the carbonization reaction, such that graphene may be formed from the cross-linked organic material.

More specifically, the cross-linked organic-thin film may be carbonized in a reheating furnace in which the inert atmosphere is maintained at 800 to 1500° C., and more preferably, 900 to 1200° C.

When the carbonization temperature is maintained at a temperature of lower than 800° C. the carbonization reaction is not effectively performed, such that the conductivity characteristics of graphene may be reduced, and, when the carbonization temperature is maintained at a temperature higher than 1500° C., the conductivity may not be further increased. The carbonization reaction may be maintained at the above temperature for 0.5 to 12 hours, and more preferably, for 1 to 3 hours, such that the cross-linked organic thin film may be completely carbonized. When the carbonization reaction time is shorter than 0.5 hour, the organic thin film is not sufficiently carbonized, such that it may be difficult to form graphene, and, when the carbonization reaction time is longer than 12 hours, a lot of energy is unnecessarily consumed owing to an excessive carbonization reaction and conductivity of the formed graphene may no longer be improved.

Further, for the carbonization reaction, a thermal stabilizing operation may be further performed at 200 to 400° C. for 1 to 3 hours. In the carbonization reaction and the thermal stabilizing operation, the inert atmosphere needs to be maintained, and the inert gas may be at least one or two kinds selected from, nitrogen, helium, neon, argon, xenon, or a mixed gas thereof, but the present invention is not limited thereto.

In another aspect of the present invention, an organic thin film may be patterned. After an organic material solution is applied to a substrate to form the organic thin film, a pattern mask having a pattern is positioned on the organic thin film and irradiated with radiation, thereby cross-linking the organic thin film. Afterwards the mask is removed, a non-cross-linked portion is removed from the organic thin film to form an organic material pattern, and the formed organic material pattern is carbonized, thereby forming a conductive pattern.

More specifically, a process of forming the organic thin film, a process of irradiating the formed organic thin film with the radiation to cross-link the irradiated organic thin film, and a process of carbonization may be the same as those in the above aspect of the present invention. The portion that is not exposed to the radiation ray to thereby be not cross-linked in the organic thin film formed with this pattern may be removed, and, when the portion that is not cross-linked is removed, the same solvent as the solvent used to prepare an organic material solution may be effectively used.

The present invention provides graphene prepared by the above method. In addition, the graphene may include a conductive pattern.

Further, the graphene prepared according to the present invention may be used as a conductive thin film, a transparent electrode, and a memory device, but is not limited thereto.

Hereinafter, the present invention will be described in detail through Examples. However, the following Examples illustrate the present invention, but the scope of the present invention is not limited to these following Examples.

### Example 1

Preparation of Graphene from Polyacrylonitrile Homopolymer Using an Ion Beam

1 g of polyacrylonitrile (molecular weight: 150,000, Aldrich Co.) was dissolved in 19 g of dimethylformamide, thereby preparing a polyacrylonitrile solution having a solid content of 5 weight %. Each of the prepared organic material solutions was spin-coated on a silicon substrate to form a polyacrylonitrile thin film. As shown in the following Table 1, the cross-reaction of the polyacrylonitrile thin film was performed by irradiating the thin film with a 150 keV hydrogen (H⁺) ion beam at a irradiation amount of 2×10¹⁵ ions/cm². Here, the thickness of the thin film is 0.03 μm (30 nm). As an ion beam apparatus, an apparatus capable of supplying the maximum ion beam energy of 300 KeV was used. The cross-linked polyacrylonitrile thin film was put into a furnace, and a carbonization reaction was performed at 1000° C. for 1 hour while maintaining a nitrogen atmosphere, thereby preparing graphene.

### Examples 2 to 4

In Examples 2 to 4, graphene was prepared using the same method as that in Example 1 except that the ion beam irradiation amounts were 3×10¹⁵ ions/cm², 4×10¹⁵ ions/cm², and 5×10¹⁵ ions/cm², respectively.

### Examples 5 to 8

### Preparation of Graphene from Polystyrene Using an Ion Beam

In Examples 5 to 8, graphene was prepared by the same method, as those in Examples 1 to 4 except that 0.5 g of polystyrene (molecular weight: 280,000, Sigma-Aldrich Co.) was dissolved in 3.5 g of toluene to prepare a polystyrene solution having a solid content of 5 weight %, and the prepared, polystyrene solution was spin-coated on a silicon substrate, thereby forming a polystyrene thin film.

### Examples 9 to 12

### Preparation of Graphene from Pitch Using an Ion Beam

In Examples 3 to 12, graphene was prepared using the same method as those in Examples 1 to 4 except that 1 g of pitch (coal tar pitch having a softening point of 108° C., OCI Co.) was dissolved in 9 g of quinoline to prepare a pitch solution having a solid content of 10 weight %, and the prepared pitch solution was spin-coated on a silicon substrate, thereby forming a pitch thin film.

### Examples 13 to 16

### Preparation of Graphene from Rayon Using an Ion Beam

In Examples 13 to 16, graphene was prepared by the same method as those in Examples 1 to 4 except that a 40 weight % rayon solution (Grade: BR120, Mitsubishi Rayon Chemical) dissolved in toluene solvent was diluted to 1/4 to prepare a rayon solution having a solid content of 5 weight %, and the prepared rayon solution was spin-coated on a silicon substrate, thereby forming a rayon thin film.

### Examples 17 to 20

### Preparation of Graphene from Lignin Using an Ion Beam

In Examples 17 to 20, graphene was prepared by the same method as those in Examples 1 to 4 except that 1 g of lignin (molecular weight: 10,000, Aldrich Chemical Company) was dissolved in 9 g of dioxane solvent to prepare a lignin solution having a solid content of 10 weight %, and the prepared lignin solution was spin-coated on a silicon substrate, thereby forming a lignin thin film.

### Examples 21 and 22

### Preparation of Graphene from Polyacrylonitrile Homopolymer Using an Electron Beam

In Examples 21 and 22, graphene was prepared by the same method as that in Example 1 except that, polyacrylonitrile thin films were irradiated with electron beams at an irradiation, amount of 1×10¹⁶ electrons/cm² and 1×10¹⁸ electrons/cm², respectively, using a 10 MeV electron beam accelerator (model name: UELV-10-10S, Advanced Radiation Technology Institute (ARTI).

### Examples 23 and 24

### Preparation of Graphene from Polystyrene Using an Electron Beam

In Examples 23 and 24, graphene was prepared using the same method as that in Example 1 except that 0.5 g of polystyrene (molecular weight: 280,000, Sigma-Aldrich Co.) was dissolved in 9.5 g of toluene to prepare a polystyrene solution having a solid content of 5 weight %, and the prepared polystyrene solution was spin-coated on a silicon substrate, thereby forming a polystyrene thin film, and at the time of irradiation of the radiation rays, the polystyrene thin films were irradiated with electron beams at an irradiation amount of 1×10¹⁶ electrons/cm² and 1×10¹⁸ electrons/cm², respectively, using a 10 MeV electron beam accelerator (model name: UELV-10-10S, ARTI).

### Examples 25 and 26

### Preparation of Graphene from Pitch Using an Electron Beam

In Examples 25 and 26, graphene was prepared using the same method as those in Examples 21 and 22 except that 1 g of pitch (coal tar pitch with a softening point of 108° C., OCX Co.) was dissolved in 9 g of quinoline to prepare a pitch solution having a solid content of 10 weight %, and the prepared pitch solution was spin-coated on a silicon substrate, thereby forming a pitch thin film.

### Examples 27 and 28

### Preparation of Graphene from Rayon Using an Electron Beam

In Examples 27 and 28, graphene was prepared using the same method as those in Examples 21 and 22 except that a 40 weight % rayon solution (Grade: BR120, Mitsubishi Rayon Chemical) dissolved in toluene solvent was diluted to 1/4 to prepare a rayon solution with a solid content of 5 weight %, and the prepared rayon solution was spin-coated on a silicon substrate, thereby forming a rayon thin film.

### Examples 29 and 30

### Preparation of Graphene from Lignin Using an Electron Beam

In Examples 29 and 30, graphene was prepared by the same method as those in Examples 21 to 22 except, that 1 g of lignin (molecular weight: 10,000, Aldrich Chemical Company) was dissolved in 9 g of dioxane solvent to prepare a lignin solution having a solid content of 10 weight. %, and the prepared lignin solution was spin-coated on a silicon substrate, thereby forming a lignin thin film.

### Comparative Example 1

### Preparation of Graphene from Polyacrylonitrile

Polyacrylonitrile was dissolved in dimethylformamide to prepare a polyacrylonitrile copolymer solution having a solid content of 5 weight %, and the prepared copolymer solution was spin-coated on a silicon substrate, thereby forming a polyacrylonitrile thin film. The polyacrylonitrile thin film was put into a furnace, and the carbonization reaction was performed at 1000° C. for 1 hour while maintaining a nitrogen atmosphere, thereby preparing the graphene.

### Comparative Example 2

### Preparation of Graphene from Polystyrene

0.5 g of polystyrene (molecular weight: 280,000, Sigma-Aldrich Co.) was dissolved in 9.5 g of toluene to prepare a polystyrene solution having a solid content of 5 weight %, and the prepared polystyrene solution was spin-coated on a silicon substrate, thereby forming a polystyrene thin film. The polystyrene thin film, was put into a furnace, and carbonization reaction was performed at 1000° C. for 1 hour while maintaining a nitrogen, atmosphere, thereby preparing the graphene.

TABLE 1

| | Kinds | Irradiation | Kinds of | |
|---|---|---|---|---|
| | of used | energy of the | the used | Irradiation |
| Examples | polymer | used radiation | radiation | amount |
| Example 1 | Poly- | 150 keV | Hydro- | 2 × 10¹⁵ ions/cm² |
| Example 2 | acrylo- | | gen(H⁺) | 3 × 10¹⁵ ions/cm² |
| Example 3 | nitrile | | ion beam | 4 × 10¹⁵ ions/cm² |
| Example 4 | | | | 5 × 10¹⁵ ions/cm² |
| Example 5 | Poly- | 150 keV | Hydro- | 2 × 10¹⁵ ions/cm² |
| Example 6 | styrene | | gen(H⁺) | 3 × 10¹⁵ ions/cm² |
| Example 7 | | | ion beam | 4 × 10¹⁵ ions/cm² |
| Example 8 | | | | 5 × 10¹⁵ ions/cm² |
| Example 9 | Pitch | 150 keV | Hydro- | 2 × 10¹⁵ ions/cm² |
| Example 10 | | | gen(H⁺) | 3 × 10¹⁵ ions/cm² |
| Example 11 | | | ion beam | 4 × 10¹⁵ ions/cm² |
| Example 12 | | | | 5 × 10¹⁵ ions/cm² |
| Example 13 | Rayon | 150 keV | Hydro- | 2 × 10¹⁵ ions/cm² |
| Example 14 | | | gen(H⁺) | 3 × 10¹⁵ ions/cm² |
| Example 15 | | | ion beam | 4 × 10¹⁵ ions/cm² |
| Example 16 | | | | 5 × 10¹⁵ ions/cm² |
| Example 17 | Lignin | 150 keV | Hydro- | 2 × 10¹⁵ ions/cm² |
| Example 18 | | | gen(H⁺) | 3 × 10¹⁵ ions/cm² |
| Example 19 | | | ion beam | 4 × 10¹⁵ ions/cm² |
| Example 20 | | | | 5 × 10¹⁵ ions/cm² |
| Example 21 | Poly- | 10 MeV | Electron | 1 × 10¹⁶ |
| | acrylo- | | beam | electrons/cm² |
| Example 22 | nitrile | | | 1 × 10¹⁸ |
| | | | | electrons/cm² |
| Example 23 | Poly- | 10 MeV | Electron | 1 × 10¹⁶ |
| | styrene | | beam | electrons/cm² |
| Example 24 | | | | 1 × 10¹⁸ |
| | | | | electrons/cm² |
| Example 25 | Pitch | 10 MeV | Electron | 1 × 10¹⁶ |
| | | | beam | electrons/cm² |
| Example 26 | | | | 1 × 10¹⁸ |
| | | | | electrons/cm² |
| Example 27 | Rayon | 10 MeV | Electron | 1 × 10¹⁶ |
| | | | beam | electrons/cm² |
| Example 28 | | | | 1 × 10¹⁸ |
| | | | | electrons/cm² |
| Example 29 | Lignin | 10 MeV | Electron | 1 × 10¹⁶ |
| | | | beam | electrons/cm² |
| Example 30 | | | | 1 × 10¹⁸ |
| | | | | electrons/cm² |
| Comparative | Poly- | — | — | — |
| Example 1 | acrylo- | | | |
| | nitrile | | | |
| Comparative | Poly- | — | — | — |
| Example 2 | styrene | | | |

### Experimental Example 1

### Analysis of a Chemical Structure of Graphene Prepared Through Radiation Irradiation

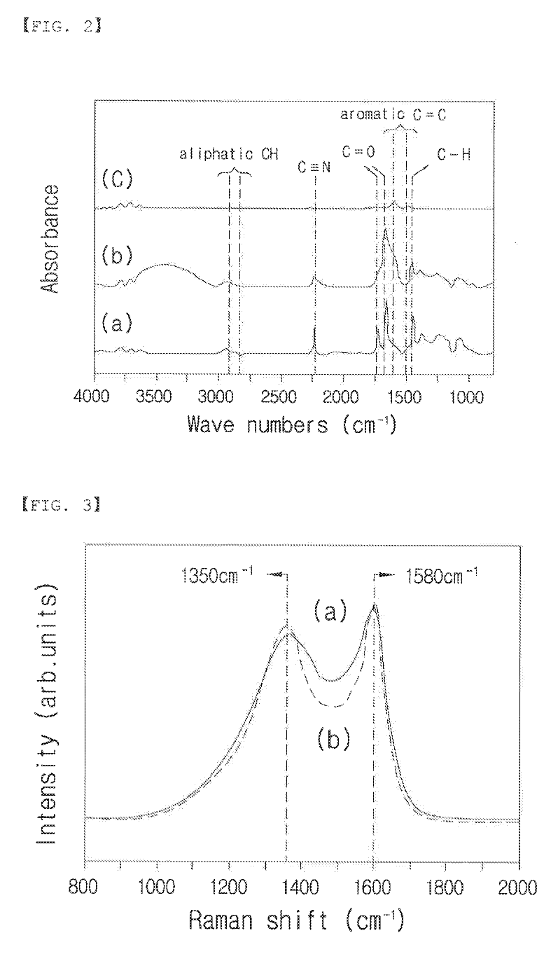

In order to analyze the chemical structures of the polyacrylonitrile thin films in Comparative Example 1 and Example 4, and the graphene prepared by carbonizing Example 4, spectra thereof were measured using a Fourier trans form-infrared spectrometer (FT-IR, model name: 640-IR, Varian Co.), and the results are shown in FIG. 2.

As shown in (a) and (b) of FIG. 2, in the case of a polyacrylonitrile irradiated with the ion beam, the peak characteristics of the polyacrylonitrile was almost similar to those of pure polyacrylonitrile except that an new broad C═O peak was generated. On the other hand, as shown in (c) of FIG. 2, it may be confirmed that, in the infrared spectrum of the graphene prepared by carbonization of Example 4, the characteristic peaks of aromatic carbon-carbon double bond in a hexagonal ring presented in carbon-based materials such as a carbon nanotube, graphite, graphene, or the like, is newly generated.

Based on the above results, it may be confirmed that the cross-link structure of polyacrylonitrile is effectively formed by irradiation of the ion beam, and the aromatic hexagonal carbon structure, which is a characteristic structure of graphene, is well formed through carbonization reaction.

Through repetitive experiments, it may be confirmed that the aromatic hexagonal carbon, structure is formed in the graphene prepared from polystyrene, pitch, rayon, and lignin through the ion beam irradiation like the case of polyacrylonitrile, and the quality of the formed graphene is equal to formed from polyacrylonitrile.

### Experimental Example 2

### Analysis of Aromatic Hexagonal Carbon Structure of Graphene Prepared by Irradiation with Radiation

In order to confirm whether an aromatic hexagonal carbon structure of graphene prepared by irradiation with radiation is formed, a structure analysis was performed using a Raman spectrometer (model name: LabRam HR, Horiba jobin-Yvon Co.), and the results are shown in FIG. 3. A Raman, spectrum of the graphene prepared in Comparative Example 1 is shown in (a) of FIG. 3, and a Raman spectrum of the graphene prepared in Example 4 is shown in (b) of FIG. 3. As shown in FIG. 3, it may be confirmed that both of the spectra of (a) and (b) have peaks at 1580 cm⁻¹ and 1350 cm⁻¹. It has been known that the two peaks are present, in graphite based, materials with an aromatic hexagonal structure. More specifically, the peak at 1580 cm⁻¹ indicates that a carbon structure having electrical conductivity was formed and the peak at 1350 cm⁻¹ indicates that an amorphous carbon structure was formed in the process of carbonization rather than a perfect crystal structure. Through the above results, it may be confirmed that the aromatic hexagonal carbon structure is better formed in the graphene prepared from the cross-linked polyacrylonitrile than in the graphene prepared from, non-crosslinked polyacrylonitrile, and a more uniform graphene with a well-formed crystal structure may be prepared through radiation-induced crosslinking. In addition, through repetitive experiments for the above Examples, it may be confirmed, that an aromatic hexagonal carbon structure is well formed in the graphene prepared from polystyrene, pitch, rayon, and lignin and the graphene equal to the graphene prepared from polyacrylonitrile may be obtained.

### Experimental Example 3

### Analysis of Chemical Compositions of Graphene Prepared by Irradiation with Radiation

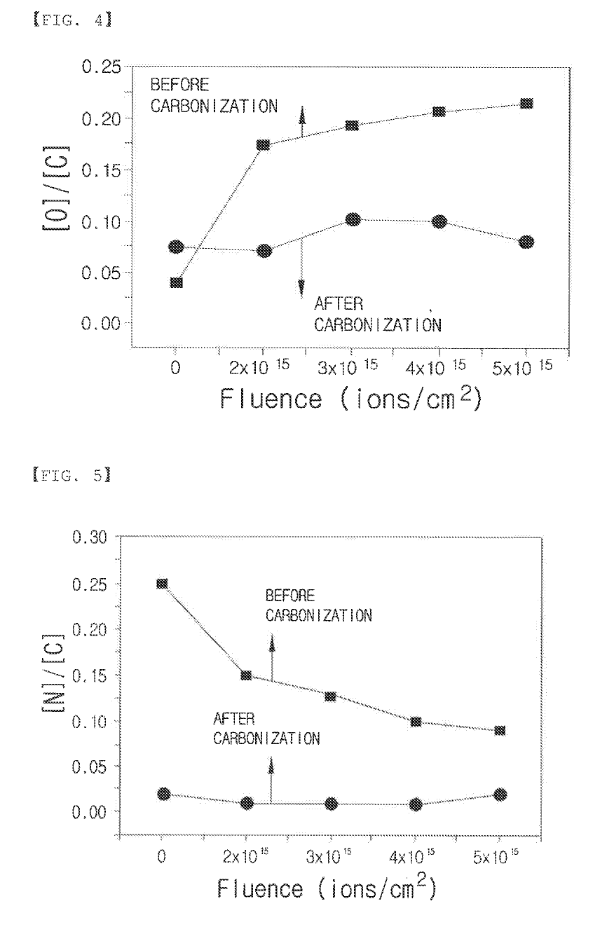

In order to analyze the chemical composition of the graphene prepared using radiation-induced crosslinking, analysis was performed using an X-ray photoelectron spectrometer (XPS, Sigma Probe, Thermo VG Scientific), and the results are shown in FIGS. 4 and 5. Before carbonization, as the ion beam irradiation amount increases, the element ratio of oxygen to carbon ([O]/[C]) increases as shown in FIG. 4. On the other hand, the element ratio of nitrogen to carbon ([N]/[C]) relatively decreases as shown in FIG. 5. This increase in the oxygen content means that uniform aromatic hexagonal structure may be further efficiently formed in the process of carbonization. In addition, the ratios of oxygen to carbon and nitrogen to carbon of the graphene prepared through carbonization were 0.1 or less, confirming that oxygen and nitrogen elements are completely removed in the process of carbonization, such that only pure carbon elements are present in the prepared graphene.

Further, through repetitive experiments, it may be confirmed that the other elements such as oxygen and nitrogen elements except for carbon are completely removed in the process of carbonization and only pure carbon element is present in the graphene prepared from polystyrene, pitch, rayon, and lignin.

### Experimental Example 4

### Measurement of Electrical Conductivity of Graphene Prepared by Irradiation with Radiation

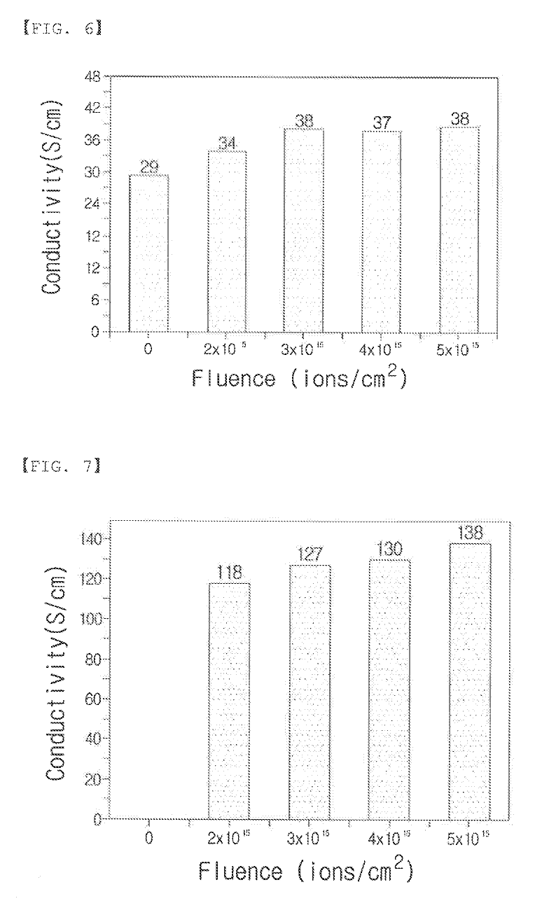

The conductivities of the graphene prepared by irradiation of the radiation ray were measured using a resistance meter (model name; MCPP-T610, Mitsubishi Chemical Corporation), and the results are shown in FIGS. 6 and 1. As shown in FIG. 6, the conductivity in Comparative Example 1 was 29 S/cm, but the conductivities in Examples 1 to 4 were higher than in Comparative Example 1. In addition, the maximum conductivity was 40 S/cm according to the ion beam irradiation amount.

In addition, as shown in FIG. 7, in the case of Comparative Example 2, the polystyrene thin film was not cross-linked to thereby be completely combusted in the process of carbonization, such that the conductivity was 0 S/cm. However, in the case, of Example 23, the polystyrene thin film was effectively cross-linked by ion beam irradiation to thereby not be completely combusted in the process of carbonization and form graphene, such that the electrical conductivity appeared, wherein the maximum electrical conductivity was 138 S/cm according to the ion beam irradiation amount.

Therefore, according to the results, after the organic thin, film is irradiated with the radiation according to the present invention to thereby be crosslinked, the carbonization is performed to form graphene, such that large area graphene may be prepared at a low cost, by the simple process, and pure and high conductive graphene may be prepared.

Through a method of preparing graphene from an organic material using a radiation technique, and graphene prepared using the same according to the present invention, an expensive metal catalyst and substrate, oxidation and reduction processes, and a delicate process control may not be required as compared to the existing method. Therefore, pure graphene may be prepared on a large area at low cost, and graphene may be easily prepared. In addition, the graphene according to the present invention may be usefully used in bio-fields such as a neuron-on-a chip technology, a bio-sensor, or the like as well as in various electron device fields such as a recently prominent organic light emitting device, a solar cell, a memory device, or the like.

Exemplary embodiments of the present invention were described above, but the present invention may include various changes, modifications, and their equivalent. It will be appreciated that the present invention may be similarly applied by modifying the exemplary embodiments.

What is claimed is:

1. A method of preparing graphene characterized by forming an organic thin film on a substrate, irradiating an upper portion of the organic thin film with radiation to cross-link the organic thin film, and carbonizing the cross-linked organic thin film to form graphene.

2. The method of preparing graphene of claim 1, wherein the radiation ray is at least one kind selected from a group consisting of ion beams, electron beams, gamma rays, alpha rays, and beta rays.

3. The method of preparing graphene of claim 1, wherein the radiation ray is the ion beam, and an ion beam irradiation energy (Eᵢₒₙ) and an total ion irradiation amount (Tᵢₒₙ) satisfy the following Equations 1 and 2.
1≦Eᵢₒₙ≦300 keV [Equation 1]
1×10¹⁰≦Tᵢₒₙ≦1×10¹⁹ ions/cm² [Equation 2]

4. The method of preparing graphene of claim 1, wherein the radiation is the electron beam, and an electron beam irradiation energy (Eₑₗₑ) and an total electron irradiation amount (Tₑₗₑ) satisfy the following Equations 3 and 4,
1≦Eₑₗₑ≦1000 keV [Equation 3]
1×10¹⁴≦Tₑₗₑ≦1×10²⁰ electrons/cm² [Equation 4]

5. The method of preparing graphene of claim 1, wherein the organic thin film is formed by applying an organic material solution obtained by dissolving at least one or two kinds of organic materials selected from polyacrylonitrile homopolymers, acrylonitrile copolymers, lignin, pitch, rayon, polystyrene, and polymethylmethacrylate in a solvent to the substrate.

6. The method of preparing graphene of claim 5, wherein a content of the organic material is 0.1 to 20 weight % based, on the total weight of the organic material solution.

7. The method of preparing graphene of claim 1, wherein the organic thin film has a thickness of 0.001 to 1 μm.

8. The method of preparing graphene of claim 1, wherein the organic thin film is patterned.

9. The method of preparing graphene of claim 8, wherein the patterning is performed by positioning a mask having a pattern on the organic thin film, forming an organic pattern by irradiation of radiation rays, and carbonizing the organic pattern to form a conductive pattern.

10. The method of preparing graphene of claim 1, wherein the graphene prepared by the method is a conductive material used for a conductive thin film, a transparent electrode, or a memory device.
